(19) United States
(12) Patent Application Publication
(10) Pub. No.: US 2023/0196289 A1
(43) Pub. Date: Jun. 22, 2023

(54) AUTO-GENERATING NEWS HEADLINES BASED ON CLIMATE, CARBON AND IMPACT PREDICTIONS

(71) Applicant: INTERNATIONAL BUSINESS MACHINES CORPORATION, Armonk, NY (US)

(72) Inventors: Smitkumar Narotambhai Marvaniya, Bangalore (IN); Kedar Kulkarni, Bangalore (IN); Ranjini Bangalore Guruprasad, Bangalore (IN); Jitendra Singh, Noida (IN); Komminist Weldemariam, Ottawa (CA); Shantanu R. Godbole, Bangalore (IN); Chandrasekhar Narayanaswami, Wilton, CT (US)

(21) Appl. No.: 17/553,747

(22) Filed: Dec. 16, 2021

(51) Int. Cl. G06Q 10/10; G06N 20/00

(52) U.S. Cl. CPC G06Q 10/101; G06N 20/00

(57) ABSTRACT

A method and system generate news headlines from user input parameters. The user input parameters include a specified geographic region of interest and an industry of interest. Climate data and carbon emissions data for the specified geographic region of interest is retrieved. Supply chain dependencies are determined. A machine learning model is generated using the specified geographic region of interest, the industry, the climate data, the carbon emissions data, and the supply chain dependencies. The machine learning model performs an impact analysis on a supply chain based on the climate data and the carbon emissions data. The machine learning model predicts a supply chain performance for the industry based on the impact analysis. A news headline is automatically generated describing the predicted supply chain performance. The news headline includes an underlying basis for the predicted supply chain performance.

### BACKGROUND

### Technical Field

The present disclosure generally relates to data processing, and more particularly, to a system and method for auto-generating news headlines based on climate, carbon and impact predictions.

### Description of the Related Art

Supply chain management increasingly relies on technology to efficiently administer operations. Conventionally, an SME (subject matter expert) analyzes data, and the report generated by the explainable artificial intelligence (A.I.)/machine language (M.L.)/deep learning (D.L.) models along with domain insights to make appropriate decisions to optimize the supply chain operation.

Currently, news data is used as an input to supply chain analysis. To analyze supply chain operations, various data sources such as climate predictions, risk of disruptive events, etc., may be analyzed and correlated with explainable models (e.g., demand forecasting). There are some systems that automatically generate news as an abstract representation of facts, data, and the insights generated from explainable models. The automatically generated news may cover a broad variety of topics, many subjects of which are not necessarily of significance to supply chain operations. While helpful in a general sense, current automatically generated news leaves room for interpretation for someone in the field of supply chain operations. The source of facts for the current approaches to auto-generated news is unknown to the end reader and consequently, whether the news has any relevant meaning to a supply chain remains unknown.

### SUMMARY

According to an embodiment of the present disclosure, a method for generating news headlines is provided. The method includes receiving, from a user, user input parameters. The user input parameters include a specified geographic region of interest and an industry of interest. Climate data for the specified geographic region of interest is retrieved. Carbon emissions data for the specified geographic region of interest is retrieved. Supply chain dependencies for the industry in the specified geographic region of interest are determined. A machine learning model performs an impact analysis on a supply chain for the industry in the specified geographic region of interest based on the retrieved climate data and the carbon emissions data. The machine learning model predicts a supply chain performance for the industry based on the impact analysis. A news headline is automatically generated describing the predicted supply chain performance. The news headline includes an underlying basis for the predicted supply chain performance. The automatically generated news headline is displayed to the user through an electronic user interface.

In one embodiment, the method includes broadcasting the automatically generated news headline through an online network. The general public as well as other supply chain managers for an industry will appreciate that the news headline generated may be informative and helpful in their daily decisions. Broadcasting the content of the news headline through online channels provides the information to a much larger audience than the conventional approach involving single user query searches.

According to an embodiment of the present disclosure, a computer program product for generating news headlines is provided. The computer program product includes one or more computer readable storage media, and program instructions collectively stored on the one or more computer readable storage media. The program instructions include receiving, from a user, user input parameters. The user input parameters include a specified geographic region of interest and an industry of interest. Climate data for the specified geographic region of interest is retrieved. Carbon emissions data for the specified geographic region of interest is retrieved. Supply chain dependencies for the industry in the specified geographic region of interest are determined. A machine learning model performs an impact analysis on a supply chain for the industry in the specified geographic region of interest based on the retrieved climate data and the carbon emissions data. The machine learning model predicts a supply chain performance for the industry based on the impact analysis. A news headline is automatically generated describing the predicted supply chain performance. The news headline includes an underlying basis for the predicted supply chain performance. The automatically generated news headline is displayed to the user through an electronic user interface.

According to one embodiment, the program instructions further include attaching an indicator to the automatically generated news headline. The indicator provides a positive or negative indication of the automatically generated news headline. The indicator is a convenient and helpful technological tool that assists viewers in determining how the underlying basis of the headline may affect them at a glance without having to study and interpret the information with significant effort. Compared to traditional headlines, which can be interpreted in many different ways and are sometimes interpreted as positive when they are in actuality negative, the indicator provides a definitive interpretation of the headline content.

According to an embodiment of the present disclosure, a computer server for generating news headlines is disclosed. The computer server includes: a network connection; one or more computer readable storage media; a processor coupled to the network connection and coupled to the one or more computer readable storage media; and a computer program product including program instructions collectively stored on the one or more computer readable storage media. The program instructions include receiving, from a user, user input parameters. The user input parameters include a specified geographic region of interest and an industry of interest. Climate data for the specified geographic region of interest is retrieved. Carbon emissions data for the specified geographic region of interest is retrieved. Supply chain dependencies for the industry in the specified geographic region of interest are determined. A machine learning model is generated using the specified geographic region of interest, the industry, the retrieved climate data, the carbon emissions data, and the supply chain dependencies. The machine learning model performs an impact analysis on a supply chain for the industry in the specified geographic region of interest based on the retrieved climate data and the carbon emissions data. The machine learning model predicts a supply chain performance for the industry based on the impact analysis. A news headline is automatically generated describing the predicted supply chain performance. The news headline includes an underlying basis for the predicted supply chain performance. The automatically generated news headline is displayed to the user through an electronic user interface.

According to one embodiment, the program instructions for the computer server further comprise measuring a public reaction to the broadcasted automatically generated news headline through an online network. Generally, news headlines are generated and their impact on the public is unknown. By measuring public reaction, the system may assess the root of the reaction and adjust internal operating procedures or take public reaction into account when performing impact analysis.

In general, the embodiments disclosed will be found to provide meaningful insight and accurate predictions in supply chain operations. Supply chains may be directly impacted by factors including climate risks and carbon emissions activity. Machine learning technology in the subject embodiments will differentiate the impact climate risks and carbon activity have on different industries. The headlines will provide the underlying basis for the prediction in the headline so that end users can see the evidence behind a headline. Providing the underlying basis in an objective approach will result in increased confidence for the prediction.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of an architecture for auto-generating news headlines of supply chain predictions based on climate risk and carbon footprint impact, according to an embodiment.

FIGS. 2A and 2B are a flowchart of a method for auto-generating news headlines of supply chain predictions based on climate risk and carbon footprint impact, according to some embodiments.

FIG. 3 is a screenshot of a dashboard on a user interface for generating a client-based headline, according to an embodiment.

FIG. 4 is a flowchart of a method for generating a client personalized headline, according to an embodiment.

FIG. 5 is a block diagram of a system for auto-generating news headlines, according to an embodiment.

FIG. 6 is a flowchart of a method for controlling supply chain operations based on news predictions related to climate risk and carbon footprint impact, according to an embodiment.

FIGS. 7A and 7B are a block diagram of an autoencoder neural network model for auto-generating news headlines of supply chain predictions based on climate risk and carbon footprint impact, according to an embodiment.

FIG. 8 is a flowchart of a method for troubleshooting supply chain operations based on auto-generated news headlines, according to an embodiment.

FIG. 9 is flowchart of a method for combining news headlines, according to an embodiment.

FIG. 10 is a block diagram of a system for troubleshooting supply chain operations based on auto-generated news headlines, according to an embodiment.

FIG. 11 is a functional block diagram illustration of a computer hardware platform that can communicate with various networked components.

FIG. 12 depicts a cloud computing environment, consistent with an illustrative embodiment.

FIG. 13 depicts abstraction model layers, consistent with an illustrative embodiment.

### DETAILED DESCRIPTION

Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to systems and methods for assessing climate risks and carbon footprint impact on supply chain operations. Generally, the embodiments may be practiced in the fields of computers and computer networks.

In the subject disclosure that follows, embodiments propose a system that that generates auto-generated, explainable news headlines for supply chains based on predicted analysis of climate risks and carbon footprint. Artificial intelligence is used to process climate data and carbon footprint based data to predict outcomes that will affect supply chain operations. The outcomes are presented with a prediction that is supported by evidence included in the automatically generated headline. Unlike current auto-generated news, aspects of the subject disclosure use climate risk data and carbon footprint data to train a model that can predict with specificity how a supply chain for a specified user type will be affected. The model identifies news facts associated with supply chain operations from predicted climate risks and carbon footprint across different time scales (seasonal, daily, monthly, etc.). In some embodiments, the data and facts are hierarchically represented in knowledge graphs from the identified news facts. Explainable news headlines are generated using trained machine learning models for different classes of users (for example, the general public, a supply chain operation manager, etc.). In some embodiments, feedback from general public reactions of the auto generated news headlines is analyzed to auto-update supply chain operations. As should be understood, the implementation of the subject technology exceeds the manpower required to process a similar batch of news data, climate data, and carbon footprint data from different regions of the world. The time required to manually assemble and calculate the same predictions would exceed the manual ability to output a prediction in time to make the prediction worthwhile or meaningful for adjusting supply chain operations. Further, the teachings herein provide a technical improvement by increasing the accuracy in computing devices that are particularly configured to calculate various aspects of supply chain issues, as well as reduce the number of resources involved in curing supply chain problems.

### Example Architecture

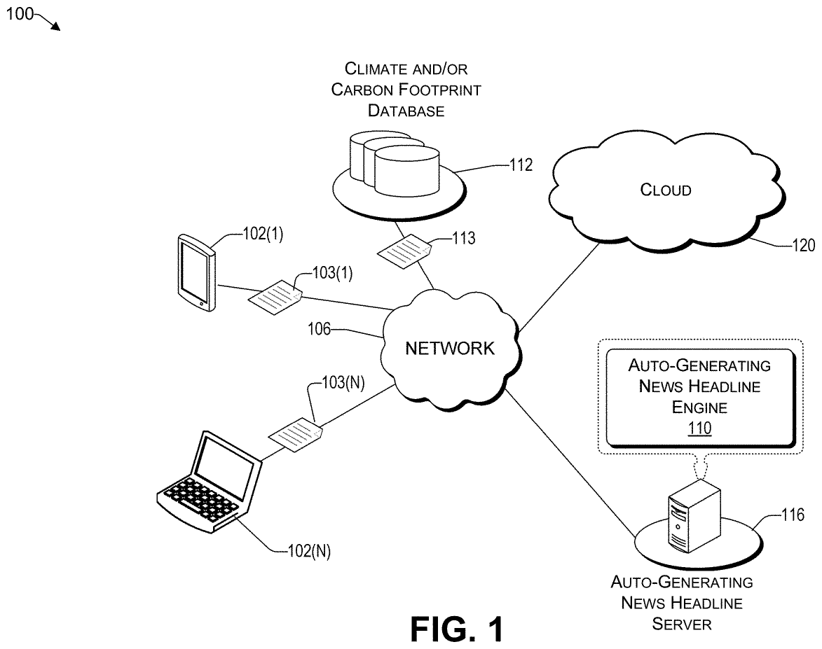

FIG. 1 illustrates an example architecture 100 for software upgrade stability recommendations and scheduling. Architecture 100 includes a network 106 that allows various computing devices 102(1) to 102(N) to communicate with each other, as well as other elements that are connected to the network 106, such as a climate and/or carbon footprint data source 112, an auto-generating news headline server 116, and the cloud 120.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet that provides various ancillary services, such as communication with various application stores, libraries, and the Internet. The network 106 allows an auto-generating news headline engine 110, which is a software program running on the auto-generating news headline server 116, to communicate with the climate and/or carbon footprint data source 112, computing devices 102(1) to 102(N), and the cloud 120, to provide data processing. The climate and/or carbon footprint data source 112 may provide climate and/or carbon footprint activity data that will be processed under one or more techniques described here. In one embodiment, the data processing is performed at least in part on the cloud 120.

For purposes of later discussion, several user devices appear in the drawing, to represent some examples of the computing devices that may be requesting or accessing supply chain prediction information. Aspects of the symbolic sequence data (e.g., 103(1) and 103(N)), which may represent requests for supply chain news predictions, may be communicated over the network 106 with the auto-generating news headline engine 110 of the auto-generating news headline server 116. Today, user devices typically take the form of portable handsets, smart-phones, tablet computers, personal digital assistants (PDAs), and smart watches, although they may be implemented in other form factors, including consumer, and business electronic devices.

For example, a computing device (e.g., 102(N)) may send a request 103(N) to the update recommendation engine 110 to identify software versions stored in the computing device 102(N).

While the climate and/or carbon footprint data source 112 and the auto-generating news headline engine 110 are illustrated by way of example to be on different platforms, it will be understood that in various embodiments, the climate and/or carbon footprint data source 112 and the auto-generating news headline server 116 may be combined. In other embodiments, these computing platforms may be implemented by virtual computing devices in the form of virtual machines or software containers that are hosted in a cloud 120, thereby providing an elastic architecture for processing and storage.

### Example Methodology

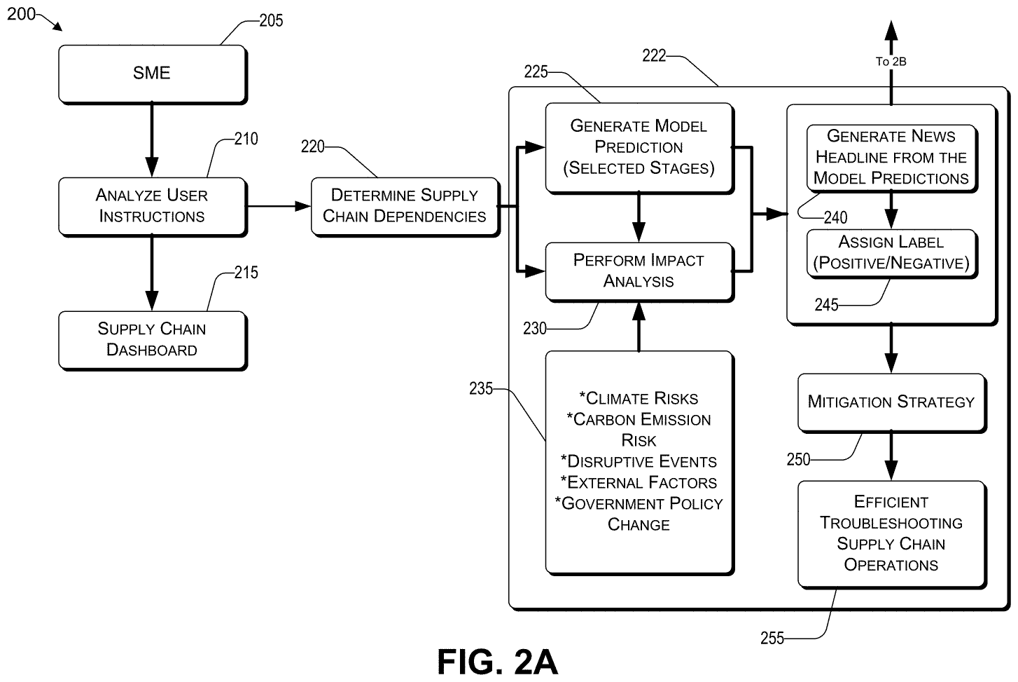

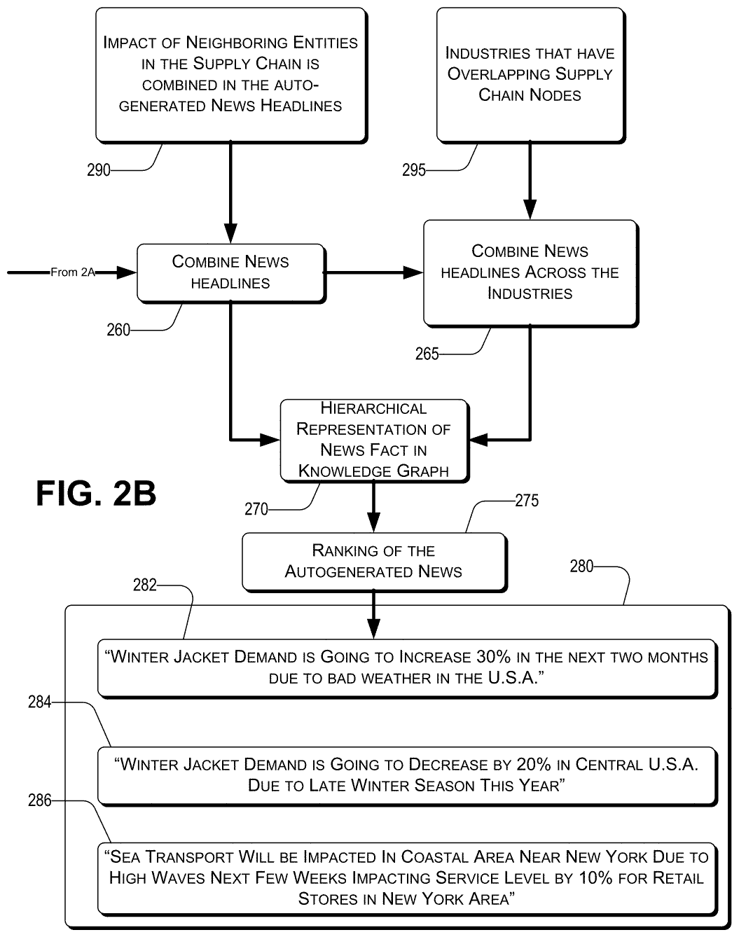

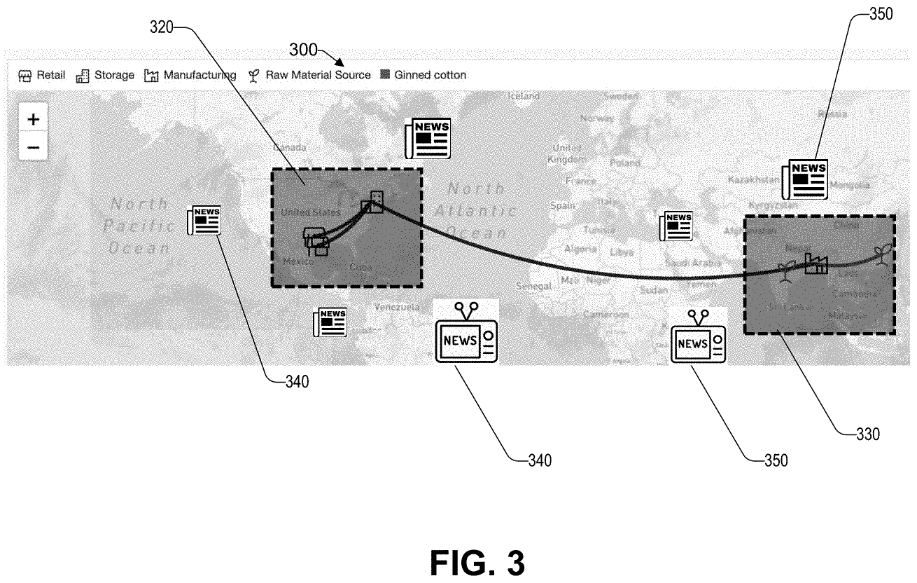

Referring now to FIGS. 2A and 2B, a method 200 for auto-generating news headlines of supply chain predictions based on climate risk and carbon footprint impact is shown, according to an illustrative embodiment. The method 200 may be triggered in response to one or more users requesting 205 supply chain prediction information. The auto-generating news headline engine 110 may analyze 210 the user request instructions to determine the kind of supply chain related information to analyze. The instructions may include parameters to be considered when the auto-generating news headline engine 110 selects data for modeling and predicting outcomes in the user's supply chain of interest. The parameters may be provided through a user interface dashboard. (See for example FIG. 3). Some of the personalization parameters such as region of interest, climate risks, carbon emission risks, and disruptive events, and external factors (e.g., government policy change) which will be used while generating the news headlines. Disruptive events may include for example, news events that include social or life affecting phenomena that potentially impact supply chains. Examples, include holidays, economic upturns or downturns, civil disobedience, employment strikes, employment increases or shortages, pandemics, and other events where the behavior of people affects supply chains. In some embodiments, the output from the auto-generating news headline engine 110 may be displayed 215 through a user interface dashboard. The auto-generating news headline engine 110 may determine 220 the supply chain dependencies related to the information/parameters (block 235) provided by the user. The auto-generating news headline engine 110 builds various AI/ML prediction models, explainable models, and uncertainty-aware models for a given task for a sub-portion of the supply chain. The auto-generating news headline engine 110 identifies all possible dependencies such as climate predictions, carbon emission metrics, prediction models, etc. for each of the identified stages in the supply chain of user interest. In some embodiments, two different types of headlines may be generated: a client specific headline and/or an industry specific headline.

Block 222 represents a section of the process that provides client specific news headline generation. The auto-generating news headline engine 110 may generate 225 predictions from a model based on the user input parameters. An impact analysis on the supply chain of interest may be performed 230. The impact analysis may be based on the climate risk and carbon impact related to the user input parameters 235. The auto-generating news headline engine 110 may generate 240 a news headline based on the prediction and impact analysis. The news headline generated may include a basis for the prediction shown within the news headline. In some embodiments, the generated news headline may include a label 245 indicating a positive or negative headline. Some embodiments may generate a mitigation strategy 250 that is provided to the user. In some embodiments, the auto-generating news headline engine 110 may include an automatic troubleshooting module that auto-troubleshoots 255 supply chain operations. [Based on the estimated demand, lead time and inventory optimization, the resiliency policies or mitigation strategies are automatically generated and is linked to the auto-generated news headlines. Resiliency policies or mitigation strategies are recommendations with quantifiable outcomes in terms of lead times which will feed into inventory optimization. These mitigation strategies are applied after review with SMEs to effectively enable one-click trouble shooting of supply chain operations based on auto-generated news headlines.

The subject matter in FIG. 2B represents the section of the process that generates an industry specific news headline. The news generated from block 245 may be used to determine whether news headline content may be combined for an industry specific prediction. In some embodiments, the impact 290 of neighboring entities or nodes of the supply chain in the supply chain is considered when combining 260 the autogenerated news headlines. In some embodiments, news headlines from across different but related industries (for example, have overlapping nodes in the supply chain) are combined 265. In some embodiments, when combining news headlines, the source of headlines may be based on industries that have overlapping supply chain nodes. For example, in a textile supply chain and medical supplies supply chain, a cotton growing stage can be considered as a node in these supply chains. Some embodiments may provide a hierarchical representation of news facts in a knowledge graph 270. Ranking of the auto-generated news headlines may be based for example, on the identified impact to the supply chain. Block 280 shows three examples of autogenerated news headlines that are industry specific. Headline 282 represents a prediction for the winter apparel industry. The headline may be indicated as positive for the industry. As can be seen, the content of headline 282 includes a basis for the prediction, which is due to bad weather over the next two months. By comparison, headline 284 may be indicated as a negative prediction for the same winter apparel industry in a specific region (central U.S.). Headline 286 may also be considered negative for the general retail industry. Headline 282 is displayed hierarchically first because it has the most direct impact to the user who is in the winter apparel industry.

FIG. 3 shows a user interface dashboard 300 according to an illustrative embodiment. The user may ask for information based on one or more regions 320 and 330. For the region 320, the auto-generating news headline engine 110 may pull news sources 340 that includes facts about region 320 or news sources 340 that are generated within region 320. The auto-generating news headline engine 110 may generate news predictions impacting region 320 based on the modelling of content included in the news sources 340. Similarly, the auto-generating news headline engine 110 may pull news facts 350 associated with region 330. Supply chain predictions affecting region 330 may be based on the content included in news sources 350.

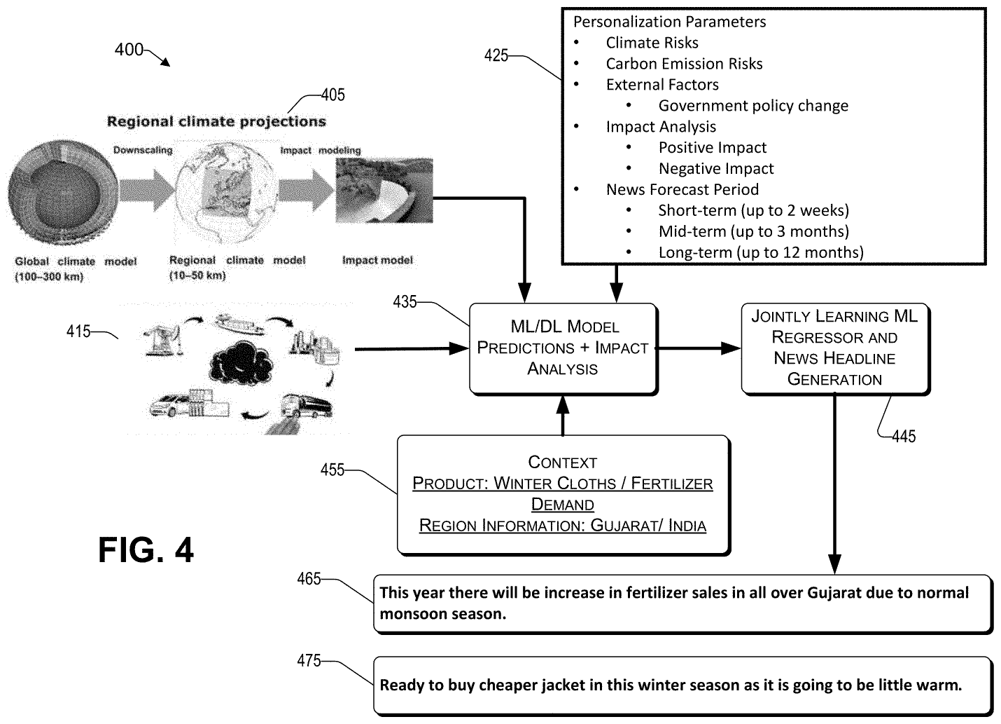

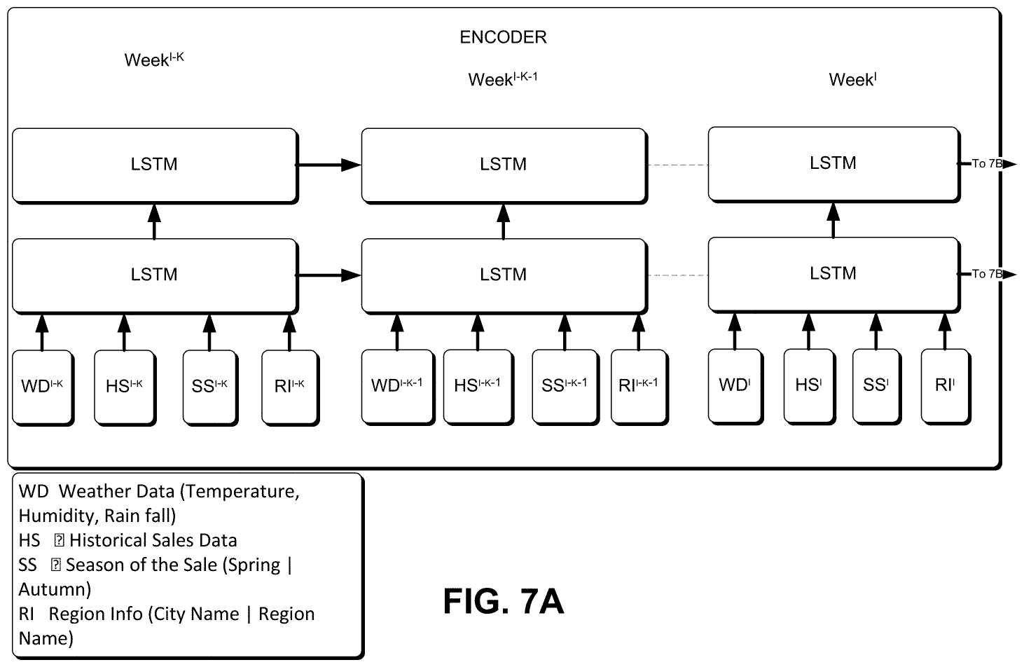

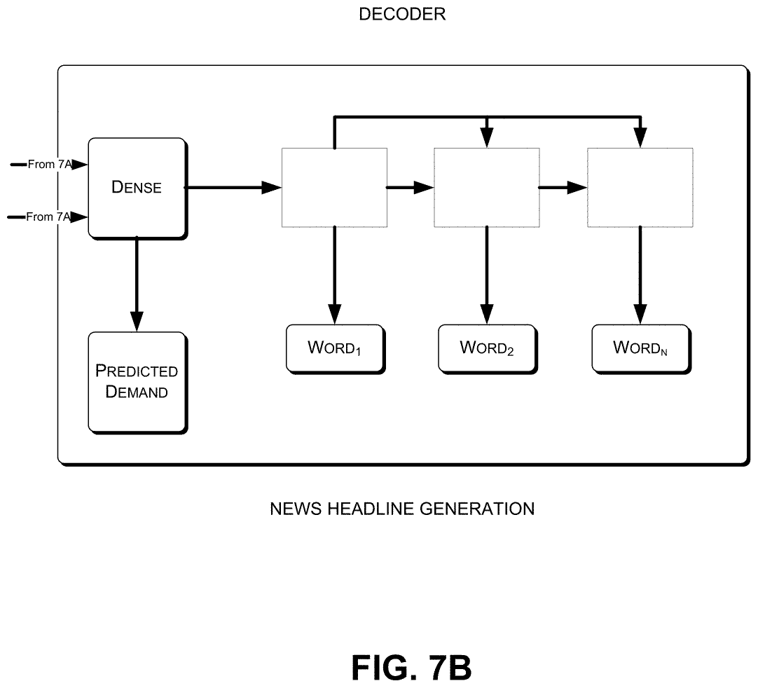

FIG. 4 shows a method 400 for generating a client personalized headline. The method 400 may generate headlines for the general public. The auto-generating news headline engine 110 may receive input including for example, regional climate projections 405, regional carbon emissions levels 415, and personalized parameters 425. The input may be used by a machine learning/deep learning model to predict 425 supply chain conditions and impact. In the illustrative example shown, the context 455 of the modelling and predictions is based on a combined product input of winter clothing and fertilizer demand for the supply chain in Gujarat, India. The deep learning model is trained 445 by minimizing the cross-entropy loss function and the task-specific regressor loss function (MSE). An illustrative embodiment of an autoencoder used to automatically generate a news headline from climate data for a region is shown in FIGS. 7A and 7B. While long short-term memory architecture is shown for the architecture, it will be understood that other types of architectures may be used. Based on the user interaction, the underlying DL model gets modified weather to include certain factors while generating news headlines. The system performs impact analysis by estimating the positive/negative impact on the supply chain disruption. An explainable DL model identifies the positive/negative factors that are contributing the most for the downstream task. Examples of predictions are shown as headline 465 and headline 475. Headline 465 shows a general prediction related to fertilizer sales for the region due to an expected climate factor. Headline 475 shows a prediction related to a general recommendation to purchase a winter jacket because of weather is expected to be warm thus implying demand will be lower.

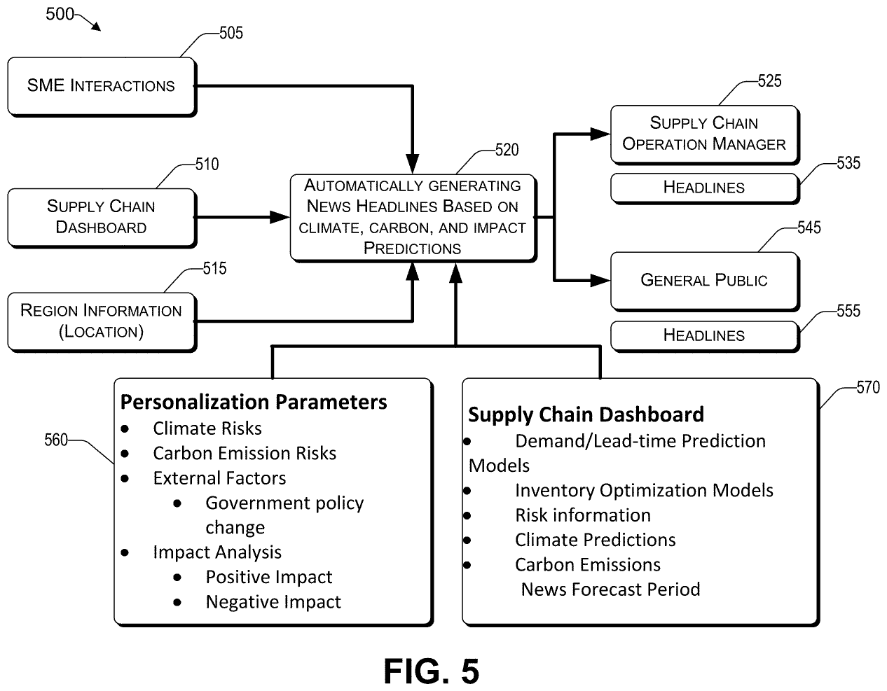

FIG. 5 shows a system 500 architecture for generating news headlines based on machine learning modelling. The modelling for automatically generated news headlines 520 based on climate, carbon emissions, and impact predictions may use inputs from blocks 505, 510, 515, 560, and 570, the descriptions of which have been previously disclosed. The type of headline generated may depend on whether the user is a specific type. For example, a supply chain operation manager 525 may receive a supply manager tailored headline 535. The headline 535 may include information that is more salient to a supply chain person than the general public. Headline 286 in FIG. 2B shows an example of a supply chain user targeted headline. A general public user 545 may receive a headline 555 that is more general in the content. Headline 475 in FIG. 4 is an example of a general user tailored headline.

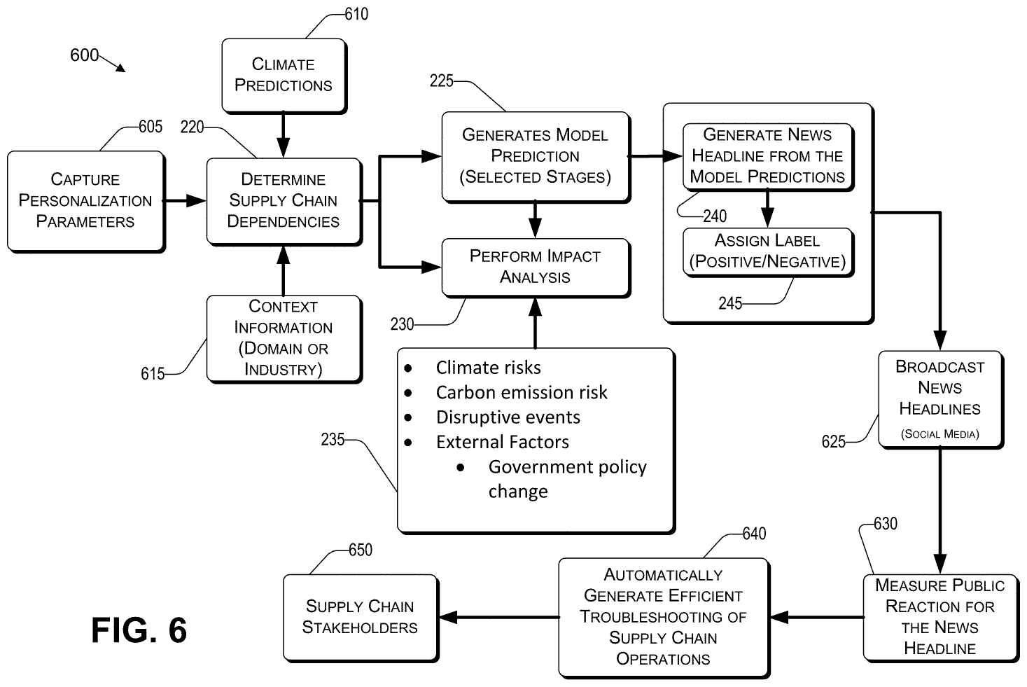

FIG. 6 shows a method 600 of controlling supply chain operations based on news predictions related to climate risk and carbon footprint impact according to an embodiment. In the method 600, some steps are familiar from discussion in previous figures and are numbered similarly. Accordingly, to avoid repetition and for the sake of brevity, those steps with like numbering in previous figures will not be described again. The auto-generating news headline engine 110 may capture 605 personalization parameters. The steps for predicting supply chain impacts from climate predictions 610, context information 615, supply chain dependencies 220, and parameters 235 is similar to the process disclosed in FIGS. 2A and 2B. In an illustrative embodiment, the auto-generating news headline engine 110 may broadcast 625 news headlines generated from the modelling predictions. Broadcasts may be to the general public using any type of media including television, radio, telephony, Internet-based, and social media. For those media avenues that provide viewer/listener audience metrics, some embodiments may measure 630 public reaction for any of the auto-generated news headlines according to the subject disclosure. Depending on the positive/negative feedback on the auto-generated headlines, the resiliency policy and hence trouble shooting of the supply chain operations may be selected to keep in line with the feedback received. The auto-generating news headline engine 110 may automatically troubleshoot 640 the supply chain operations. In some embodiments, the recommended troubleshooting may be provided to supply chain stakeholders 650.

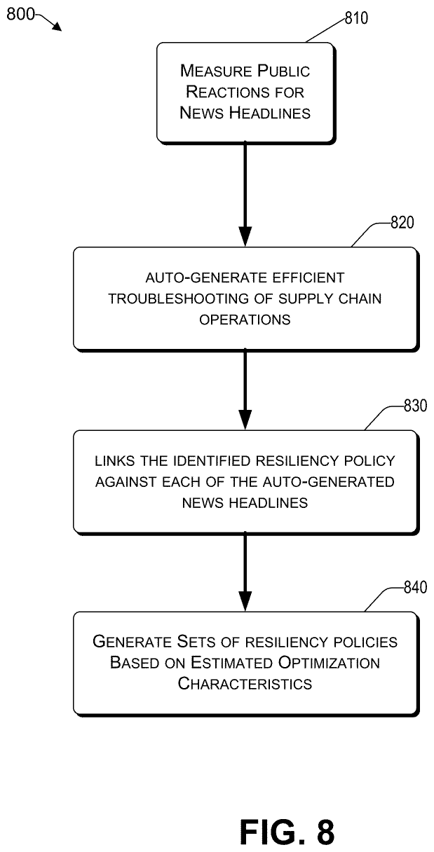

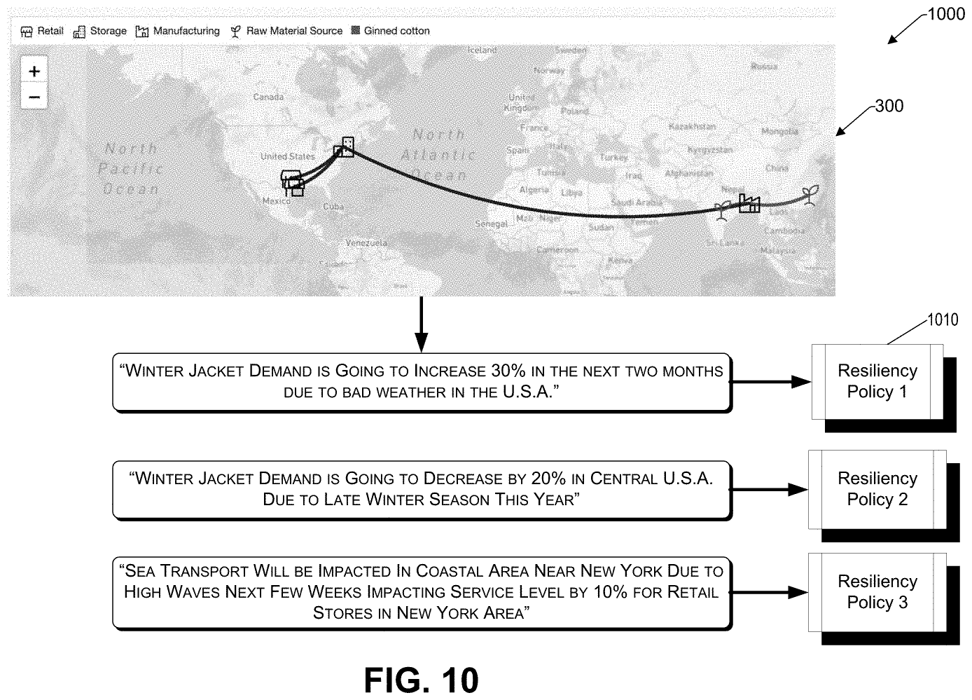

An example process 800 for troubleshooting supply chain operations is shown in FIG. 8. Trouble shooting may be either stand alone or based on feedback. If it is standalone, the resiliency policies generated based on headlines will be reviewed by SMEs and applied when appropriate. If the troubleshooting is based on feedback, the auto-generated headlines along with resiliency policy generation is performed taking the feedback direction, positive or negative, into consideration. The trouble shooting is implementing the resiliency policy. For instance, if a particular region is affected by bad weather, a resiliency policy would be to include or consider alternate suppliers from regions that are not affected by inclement weather. Troubleshooting includes sourcing from the alternate suppliers so that the lead times are not adversely affected. However, there could be multiple resiliency policies, each suggesting a different combination of suppliers and hence resulting in different costs, and lead times. The selection of the resiliency policy and implementation to trouble shoot the supply chain operations depends on the objectives to be met. The process 800 may be triggered based on a measure 810 of reaction from the public to one of the auto-generate news headlines of the subject disclosure. The system may auto-troubleshoot 820 the supply chain operation related to the news headline that received the reaction measurement. The system selects the resiliency policy that may recommend a certain action which the system will implement. For example, the supplier selection unit for a node/group of nodes in the supply chain may switch to the alternate supplier as recommended by the resiliency policy. Similarly, different functional units across the supply chain different nodes can implement the required actions as per the resiliency policy. The system links 830 an identified resiliency policy against each of the auto-generated news headlines. Given the estimate of demand and lead time by the prediction model based on various inputs such as climate, historical sales data and region, the gap between the expected and predicted demand and lead time can be determined. This gap analysis can lead to different resiliency policies (each satisfying different objectives such as cost, delivery times, carbon footprint to different extent) that reduce the gap by different extents. The system automatically generates 840 the set of resiliency policies against the estimated demand, lead-time, inventory optimization. The auto-generated mitigation strategies help in dealing with an increase/decrease in demand, increase in lead-time, and in improving user's service level. In some embodiments, the auto-generated mitigation strategies enable a one-click button 1010 (in dashboard system 1000 of FIG. 10) that triggers efficient troubleshooting of supply chain operations based on auto-generated news headlines.

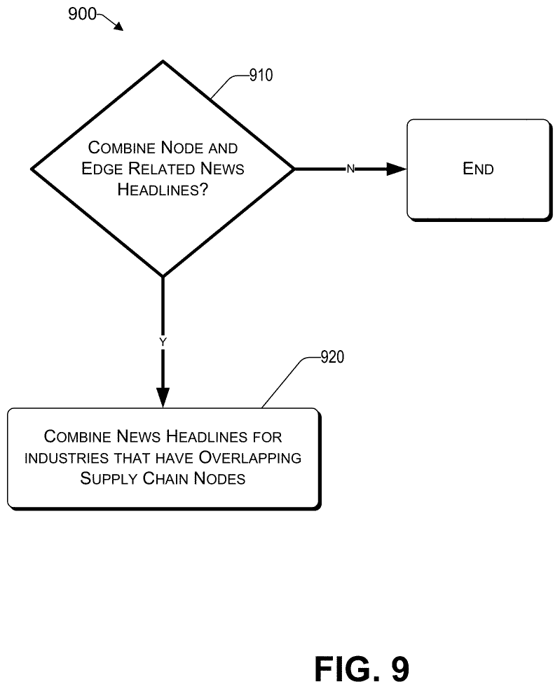

Referring now to FIG. 9, some embodiments may include a process 900 for determining when to combine headlines. The auto-generating news headline engine 110 may determine 910 whether node and edge related news headlines should be combined. For example, in a T-shirt supply chain, the region where the dyeing unit is located is hit with high rains and hence the processing of the T-shirts has to be significantly slowed down due to intermittent power supply. Also, the route that the T-shirts are to be transported are experiencing high traffic as an alternate route is closed due to cyclone. This results in combined delays at the processing unit and transportation, which when combined as headlines will enable assessing the scenario completely and generating effective resiliency policies and troubleshooting. When a determination that some headlines should be combined, the auto-generating news headline engine 110 may combine headlines for industries that have some overlapping supply chain nodes.

### Example Computer Platform

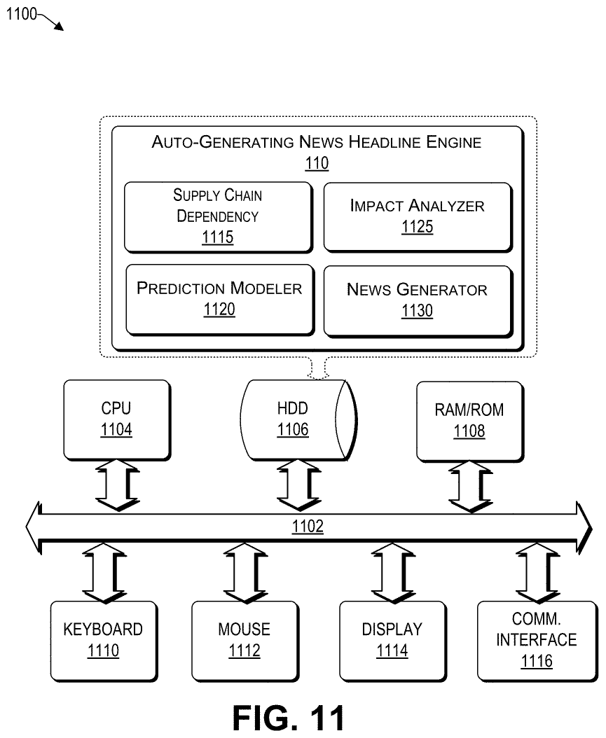

As discussed above, functions relating to interpretable modeling of the subject disclosure can be performed with the use of one or more computing devices connected for data communication via wireless or wired communication, as shown in FIG. 1. FIG. 11 is a functional block diagram illustration of a computer hardware platform that can communicate with various networked components, such as a training input data source, the cloud, etc. In particular, FIG. 11 illustrates a network or host computer platform 1100, as may be used to implement a server, such as the auto-generating news headline server 116 of FIG. 1.

The computer platform 1100 may include a central processing unit (CPU) 1104, a hard disk drive (HDD) 1106, random access memory (RAM) and/or read only memory (ROM) 1108, a keyboard 1110, a mouse 1112, a display 1114, and a communication interface 1116, which are connected to a system bus 1102.

In one embodiment, the HDD 1106, has capabilities that include storing a program that can execute various processes, such as the auto-generating news headline engine 110, in a manner described herein. Generally, the auto-generating news headline engine 110 may be configured to analyze climate data and carbon activity impact on supply chains and auto-generate news headlines indicating a basis for a prediction in the supply chain under the embodiments described above. The auto-generating news headline engine 110 may have various modules configured to perform different functions. In some embodiments, the auto-generating news headline engine 110 may include sub-modules. For example, a supply chain dependency module 1115 that determines the dependencies in a given supply chain, a prediction modeler 1120 that includes AI/ML/DL engines that generate predictive models for a given set of input parameters, an impact analyzer 1125 that analyzes and generates an estimated impact on a supply chain for a given set of news data input, and a news generator module 1130 that determines a news syntax from output provided by the prediction modeler 1120 and impact analyzer 1125 and generates news headlines.

### Example Cloud Platform

As discussed above, functions relating to analyzing the impact of a software upgrade on a computing device, may include a cloud 120 (see FIG. 1). It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

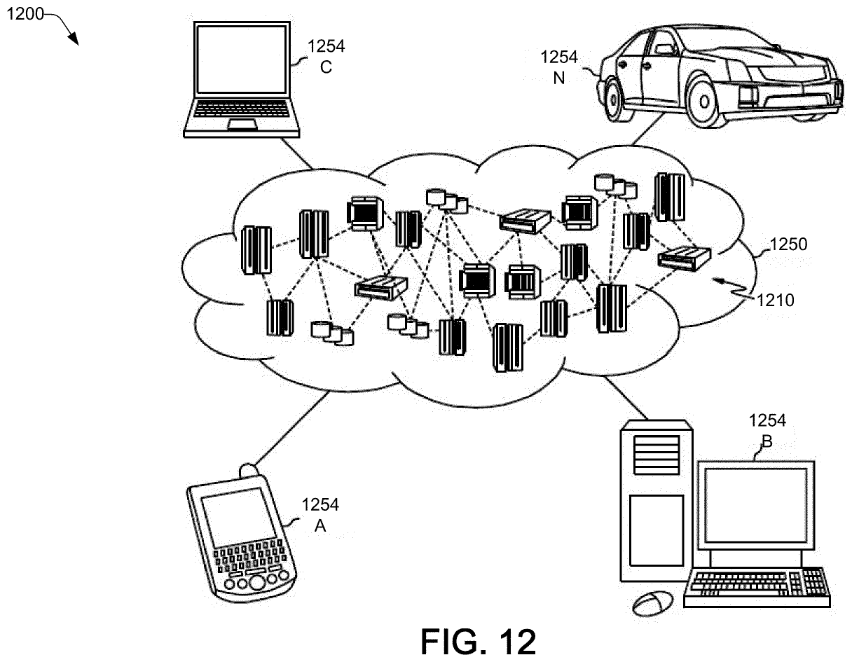

Referring now to FIG. 12, an illustrative cloud computing environment 1200 is depicted. As shown, cloud computing environment 1200 includes one or more cloud computing nodes 1210 with which local computing devices used by cloud consumers, such as, for example, personal digital assistant (PDA) or cellular telephone 1254A, desktop computer 1254B, laptop computer 1254C, and/or automobile computer system 1254N may communicate. Nodes 1210 may communicate with one another. They may be grouped (not shown) physically or virtually, in one or more networks, such as Private, Community, Public, or Hybrid clouds as described hereinabove, or a combination thereof. This allows cloud computing environment 1250 to offer infrastructure, platforms and/or software as services for which a cloud consumer does not need to maintain resources on a local computing device. It is understood that the types of computing devices 1254A-N shown in FIG. 12 are intended to be illustrative only and that computing nodes 1210 and cloud computing environment 1250 can communicate with any type of computerized device over any type of network and/or network addressable connection (e.g., using a web browser).

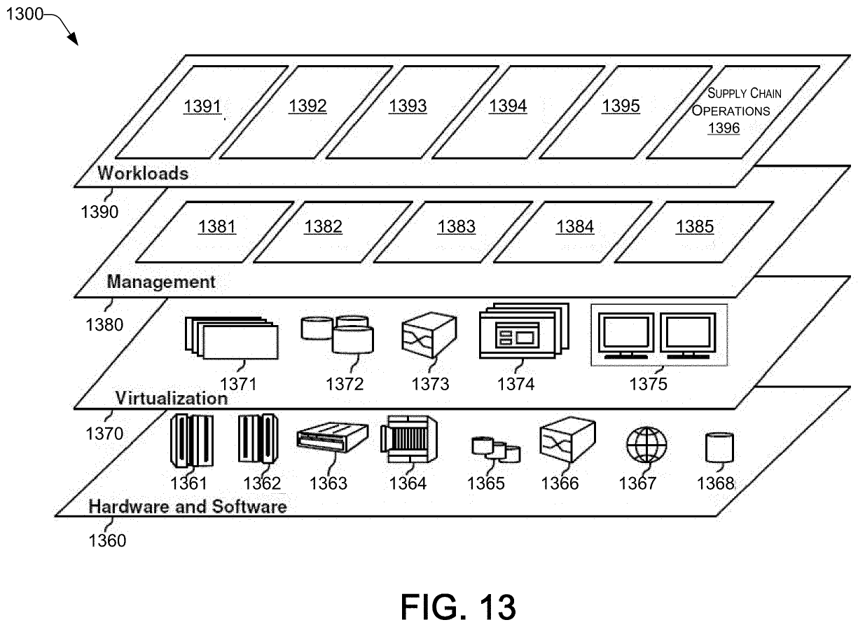

Referring now to FIG. 13, a set of functional abstraction layers provided by cloud computing environment 1250 (FIG. 12) is shown. It should be understood in advance that the components, layers, and functions shown in FIG. 13 are intended to be illustrative only and embodiments of the disclosure are not limited thereto. As depicted, the following layers and corresponding functions are provided:

Hardware and software layer 1360 includes hardware and software components. Examples of hardware components include: mainframes 1361; RISC (Reduced Instruction Set Computer) architecture based servers 1362; servers 1363; blade servers 1364; storage devices 1365; and networks and networking components 1366. In some embodiments, software components include network application server software 1367 and database software 1368.

Virtualization layer 1370 provides an abstraction layer from which the following examples of virtual entities may be provided: virtual servers 1371; virtual storage 1372; virtual networks 1373, including virtual private networks; virtual applications and operating systems 1374; and virtual clients 1375.

In one example, management layer 1380 may provide the functions described below. Resource provisioning 1381 provides dynamic procurement of computing resources and other resources that are utilized to perform tasks within the cloud computing environment. Metering and Pricing 1382 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1383 provides access to the cloud computing environment for consumers and system administrators. Service level management 1384 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 1390 provides examples of functionality for which the cloud computing environment may be utilized. Examples of workloads and functions which may be provided from this layer include: mapping and navigation 1391; software development and lifecycle management 1392; virtual classroom education delivery 1393; data analytics processing 1394; transaction processing 1395; and supply chain operations services 1396, as discussed herein.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer implemented method for generating news headlines, comprising:
receiving, from a user, user input parameters, wherein the user input parameters include a specified geographic region of interest and an industry of interest;
retrieving climate data for the specified geographic region of interest;
retrieving carbon emissions data for the specified geographic region of interest;
determining supply chain dependencies for the industry in the specified geographic region of interest;
performing, by a machine learning model, an impact analysis on a supply chain for the industry in the specified geographic region of interest based on the retrieved climate data and the carbon emissions data;
predicting, by the machine learning model, a supply chain performance for the industry based on the impact analysis;
automatically generating a news headline describing the predicted supply chain performance, wherein the news headline includes an underlying basis for the predicted supply chain performance; and
displaying the automatically generated news headline to the user through an electronic user interface.

2. The method of claim 1, further comprising broadcasting the automatically generated news headline through an online network.

3. The method of claim 2, further comprising automatically initiating a troubleshooting operation for the supply chain for the industry in the event a measurement of public reaction is negative for the automatically generated news headline.

4. The method of claim 1, further comprising training the machine learning model using the specified geographic region of interest, the industry, the retrieved climate data, the carbon emissions data, and the supply chain dependencies.

5. The method of claim 1, further comprising attaching an indicator to the automatically generated news headline, wherein the indicator provides a positive or negative indication of the automatically generated news headline.

6. The method of claim 1, further comprising:
receiving personalization parameters from the user wherein the personalization parameters include news of potentially disruptive events; and
performing the impact analysis based on the news of potentially disruptive events.

7. The method of claim 1, further comprising combining news headlines for the industry of interest with another industry in the event the industry of interest, wherein the other industry has overlapping supply chain points.

8. A computer program product for generating news headlines, the computer program product comprising:
one or more computer readable storage media, and program instructions collectively stored on the one or more computer readable storage media, the program instructions comprising:
retrieving climate data for the specified geographic region of interest;
retrieving carbon emissions data for the specified geographic region of interest;
determining supply chain dependencies for the industry in the specified geographic region of interest;
performing, by a machine learning model, an impact analysis on a supply chain for the industry in the specified geographic region of interest based on the retrieved climate data and the carbon emissions data;
predicting, by the machine learning model, a supply chain performance for the industry based on the impact analysis;
automatically generating a news headline describing the predicted supply chain performance, wherein the news headline includes an underlying basis for the predicted supply chain performance; and
displaying the automatically generated news headline to the user through an electronic user interface.

9. The computer program product of claim 8, wherein the program instructions further comprise broadcasting the automatically generated news headline through an online network.

10. The computer program product of claim 8, wherein the program instructions further comprise automatically initiating a troubleshooting operation for the supply chain for the industry in the event the measurement of public reaction is negative for the automatically generated news headline.

11. The computer program product of claim 8, wherein the program instructions further comprise training the machine learning model using the specified geographic region of interest, the industry, the retrieved climate data, the carbon emissions data, and the supply chain dependencies.

12. The computer program product of claim 8, wherein the program instructions further comprise attaching an indicator to the automatically generated news headline, wherein the indicator provides a positive or negative indication of the automatically generated news headline.

13. The computer program product of claim 8, wherein the program instructions further comprise:
receiving personalization parameters from the user wherein the personalization parameters include news of potentially disruptive events; and
performing the impact analysis based on the news of potentially disruptive events.

14. The computer program product of claim 8, wherein the program instructions further comprise combining news headlines for the industry of interest with another industry in the event the industry of interest and the other industry having overlapping supply chain points.

15. A news generation computer server, comprising:
a network connection;
one or more computer readable storage media;
a processor coupled to the network connection and coupled to the one or more computer readable storage media; and
a computer program product comprising program instructions collectively stored on the one or more computer readable storage media, the program instructions comprising:
retrieving climate data for the specified geographic region of interest;
retrieving carbon emissions data for the specified geographic region of interest;
determining supply chain dependencies for the industry in the specified geographic region of interest;
generating a machine learning model using the specified geographic region of interest, the industry, the retrieved climate data, the carbon emissions data, and the supply chain dependencies;
performing, by the machine learning model, an impact analysis on a supply chain for the industry in the specified geographic region of interest based on the retrieved climate data and the carbon emissions data;
predicting, by the machine learning model, a supply chain performance for the industry based on the impact analysis;
automatically generating a news headline describing the predicted supply chain performance, wherein the news headline includes an underlying basis for the predicted supply chain performance; and
displaying the automatically generated news headline to the user through an electronic user interface.

16. The computer server of claim 15, wherein the program instructions further comprise broadcasting the automatically generated news headline through an online network.

17. The computer server of claim 16, wherein the program instructions further comprise measuring a public reaction to the broadcasted automatically generated news headline through an online network.

18. The computer server of claim 17, wherein the program instructions further comprise automatically initiating a troubleshooting operation for the supply chain for the industry in the event the measurement of public reaction is negative for the automatically generated news headline.

19. The computer server of claim 15, wherein:
the program instructions further comprise attaching an indicator to the automatically generated news headline; and
the indicator provides a positive or negative indication of the automatically generated news headline.

20. The computer server of claim 15, wherein the program instructions further comprise:
receiving personalization parameters from the user wherein the personalization parameters include news of potentially disruptive events; and
performing the impact analysis based on the news of potentially disruptive events.
